(19) United States
(12) Patent Application Publication
(10) Pub. No.: US 2025/0312818 A1
(43) Pub. Date: Oct. 9, 2025

(54) PRIMER APPLICATOR APPARATUS AND METHOD THEREOF

(71) Applicant: Law Office of Jerry Joseph, PLC, Washington, DC (US)

(72) Inventor: Dennis A. Pressey, Pemberton, NJ (US)

(21) Appl. No.: 19/172,521

(22) Filed: Apr. 7, 2025

Related U.S. Application Data
(60) Provisional application No. 63/575,357, filed on Apr. 5, 2024.

(51) Int. Cl. B05C 21/00; B05C 1/00; B05C 11/115

(52) U.S. Cl. CPC B05C 21/00; B05C 1/00; B05C 11/115

(57) ABSTRACT

A primer applicator apparatus including an applicator member, a cover member movably coupled to the applicator member, the cover member configured to move to expose at least a portion of the applicator member, and a coupling member configured to attach the applicator member to a primer container.

### BACKGROUND OF THE INVENTION

### 1. Field of the Invention

The present general inventive concept relates to liquid and solvent applicators, and more particularly to a primer or solvent applicator and method of using the primer or solvent applicator.

### 2. Background

In the assembly of polyvinyl chloride (PVC) piping systems, a primer is used to prepare the contact surfaces of pipes and fittings. This primer acts as a solvent that cleans and softens the surfaces to promote a stronger bond when cement is applied.

Traditionally, users apply primer by repeatedly dipping a dauber into a primer can and then manually coating the surfaces. This method is not only inefficient but also poses several issues, including the risk of contaminating the primer, unintentional spillage, and uneven primer application.

Additionally, back pressure during assembly is difficult—especially when sealing pipe ends with caps—can result in partial dislodgment, making it to ensure proper fitting engagement.

Accordingly, there is a need for a tool that can consistently apply a controlled amount of primer to PVC fittings, minimize spillage, reduce contamination risk, and facilitate easier, more secure assembly.

### SUMMARY OF THE INVENTION

Certain of the foregoing and related aspects are readily attained according to the present general inventive concept by providing a primer applicator apparatus designed to attach to either standardized or custom primer containers. The apparatus includes a housing, a coupling member for secure container attachment, a fill tube for fluid transfer, and an applicator member for consistent solvent delivery.

Certain of the foregoing and related aspects are readily attained according to the present general inventive concept by also providing a primer applicator apparatus including an applicator member, a cover member movably coupled to the applicator member, the cover member configured to move to expose at least a portion of the applicator member; and a coupling member configured to attach the applicator member to a primer container.

The coupling member may further include a sealing member to prevent primer stored within the primer container from leaking through the coupling member.

The sealing member may include an O-ring. However, the present invention is not limited thereto.

The applicator apparatus may further include a fill tube disposed within the applicator member and extending into the primer container, the fill tube configured to transfer the primer to the applicator member. The fill tube may be formed from as a solid piece.

The fill tube may be hollow to allow the primer to flow to the applicator member.

The fill tube may include at least one through hole to control the flow of the primer to the applicator member. The fill tube may include at least one absorbent material to further control the flow of the primer to the applicator member.

The coupling member further includes a flow control portion to control a flow of the primer to the applicator member.

The cover member may move between a first position to a second position.

The first position of the cover member corresponds to a first length of the applicator member exposed to an external environment and the second position of the cover member corresponds to a second length of the applicator member exposed to the external environment.

The coupling member may be configured to attach to a squeezable container.

The applicator member may be composed of a porous material selected from foam, felt, bristles, or various other absorption and semi-absorption materials disposed within the main body housing, primer applicator apparatus or the fill tube.

The primer applicator may further include a removable applicator cap that, when detached, exposes a filing aperture of the container, thereby allowing the user to refill the container without requiring additional tools or modifications.

The cover member, the coupling member, and other components of the applicator apparatus may be constructed of chemical-resistant plastic.

The applicator member may include a porous material including, or formed from, one or more of foam, felt, bristles, a combination thereof or other absorbent or semi-absorbent material.

The applicator member may be removably secured and is further configured to rotate relative to the coupling member, thereby enabling replacement or adjustment of the applicator member.

The cover member may be continuously adjustable between a fully retracted position and a fully extended position, allowing variable positioning to control the extent of exposure of the applicator member.

Certain of the foregoing and related aspects are readily attained according to the present general inventive concept by also providing a method of applying primer to a surface using a primer applicator apparatus, the method includes attaching a coupling member of a primer applicator apparatus to a primer container, the primer applicator apparatus including an applicator member, a cover member movably coupled to the applicator member, and a coupling member configured to attach to the primer container, preventing leakage of the primer from the primer container by sealing the connection using a scaling member within the coupling member, allowing primer to flow from the primer container through a fill tube disposed within the applicator member, the fill tube having at least one thru-hole for controlled fluid transfer, exposing at least a portion of the applicator member by moving the cover member to a first position; and applying the primer from the applicator member onto a target surface.

The present invention is directed to a fluid dispensing tool adapted for the precise and controlled application of a liquid compound—such as an adhesive, sealant, or coating material—onto the surface of cylindrical objects, including but not limited to pipes, tubing, and pipe fittings. The tool comprises a housing or container body that may be removably secured to a variety of standard or custom made liquid supply cans or reservoirs. Upon manual, pump-assisted actuation or electrical assisted pumping, the liquid is dispensed through a top-mounted outlet to facilitate direct application onto the desired surface.

The dispensing tool is further configured with an adjustable interface or applicator section that conforms to pipes of varying diameters, ensuring targeted delivery of the fluid material while preventing excessive overflow, dripping, or mess. In exemplary embodiments, the device includes internal components that regulate the flow rate and volume of fluid dispensed, accommodating both high-viscosity and low-viscosity materials.

The present invention introduces an integrated clip or attachment feature that allows the user to secure the tool to a belt, pocket, or toolbelt for convenient access during use. The system may optionally incorporate a pumping mechanism to assist with fluid transfer from the container to the applicator outlet. The pump may be either manually operated, such as by a compressible bulb, or powered via a battery-operated motorized system. The selection between manual and electric operation allows for user customization based on application environment and preference.

The present invention introduces a specialized applicator tool designed to improve the process of applying primers and solvents to PVC pipes and fittings. It addresses key inefficiencies in traditional methods by offering precise, dual-surface application to both the inner and outer surfaces of cylindrical components. This multi-functional device enhances control and efficiency, tackling common issues such as uneven coverage, overuse of materials, and ergonomic limitations during use.

Key features of the invention include a modular applicator head that can be interchanged or adapted for use with materials of different viscosities. That is, another key feature of the present invention is its modular applicator head, which can be swapped out or customized to handle materials of varying viscosities-all while maintaining optimal control over application depth.

The tool can attach directly to standard primer or solvent cans or be paired with a secondary, optionally segmented reservoir to increase storage capacity or adjust the size for use in confined spaces. Additional precision and key features are achieved through adjustable insertion stops, enabling consistent, waste-minimizing application across a variety of project scenarios.

For user convenience, the applicator is equipped with a dedicated holder, which may include an optional belt clip for improved portability. The applicator head can be fixed, extended or rotated to match user preferences or job requirements. Overall, this solution brings enhanced practicality, reduced waste, and improved workflow to professionals working with PVC piping systems, supporting both large-scale and detailed installations in plumbing and construction industries.

In certain embodiments, the applicator member is adjustable in length and position to accommodate varying pipe diameters and insertion depths. The apparatus also optionally includes a cover member or cap that facilitates controlled exposure of the applicator during use and seals the device during storage.

Additional features and embodiments of the present general inventive concept will be apparent from the following detailed description, drawings, and claims.

### BRIEF DESCRIPTION OF THE DRAWINGS

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a front perspective view of a primer applicator apparatus, according to an exemplary embodiment of the present invention;

FIG. 2A is a front view of the primer applicator apparatus shown in FIG. 1;

FIG. 2B is a cross-sectional front view of the primer applicator apparatus taken along line A-A of FIG. 2A;

FIG. 3A is a front view of the primer applicator apparatus of FIG. 1, illustrating a cover member in a first position (P1);

FIG. 3B is a front view of the primer applicator apparatus of FIG. 1, illustrating the cover member in a second position (P2);

FIG. 4A is a cross-sectional front view of the primer applicator apparatus of FIG. 3A, showing the cover member in the first position (P1);

FIG. 4B is a cross-sectional front view of the primer applicator apparatus of FIG. 3B, showing the cover member in the second position (P2);

FIG. 5 is a front perspective view of a primer applicator apparatus, according to another exemplary embodiment of the present invention;

FIG. 6A is a front view of the primer applicator apparatus shown in FIG. 5;

FIG. 6B is a front view of the primer applicator apparatus shown in FIG. 5, illustrating hidden lines;

FIG. 6C is a cross-sectional front view of the primer applicator apparatus taken along line B-B of FIG. 6A;

FIG. 7A is a partial assembly front view of a primer applicator and holder according to another embodiment of the present invention;

FIG. 7B is a fully assembled front view of the primer applicator and the holder illustrated in FIG. 7A.

FIG. 8 is a front perspective view of a primer applicator apparatus, according to another exemplary embodiment of the present invention;

FIG. 9 is a front view of the primer applicator apparatus shown in FIG. 8; and

FIG. 10 is a front cross-sectional view of the primer applicator apparatus shown in FIG. 8, along line C-C.

### DESCRIPTION OF THE PREFERRED EMBODIMENTS

The present inventive concept will now be described more fully with reference to the accompanying drawings, in which exemplary embodiments of the present general inventive concept are illustrated. The inventive concept may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals refer to like elements throughout.

The present general inventive concept provides a primer applicator apparatus that can adjust a length of applicator pad or material that is exposed to an external environment. As such, the primer applicator apparatus allows for precise depth adjustment to ensure the primer coverage reaches the correct depth within a fitting hub. This allows users to visually monitor for any hydraulic push-out.

The present invention provides a primer applicator apparatus configured with an adjustable applicator member, allowing the exposed length of the applicator material to be precisely controlled. This adjustability ensures accurate primer coverage to the appropriate depth within a fitting hub, enabling users to visually confirm proper application and monitor for potential hydraulic push-out.

Unlike conventional primer daubers, which require constant dipping and manual handling, the present invention features a self-contained, refillable system that reduces contamination risk, enhances application consistency, and eliminates spillage. Moreover, its compatibility with both standard and custom containers adds versatility and efficiency, distinguishing it from known applicator tools.

In one embodiment, the primer applicator apparatus includes a depth-setting mechanism that permits users to finely calibrate the insertion depth of the applicator member into the fitting hub, enhancing application precision and consistency. However, the present general inventive concept is not limited thereto.

In another embodiment, the primer applicator apparatus includes a cap or cover to cover the applicator member during storage. However, the present general inventive concept is not limited thereto.

The apparatus may further include an integrated bump stop mechanism, which comprises a mechanical interface between the cover member and the applicator member. This mechanism provides tactile feedback to the user, indicating when the applicator has reached its maximum or minimum extension position. However, the present general inventive concept is not limited thereto.

In certain embodiments, the apparatus incorporates a horizontally oriented felt applicator that moves in conjunction with the bump stop. When the bump stop contacts the end of the fitting, the felt applicator delivers primer to the edge surface, ensuring complete and uniform coverage.

The primer applicator apparatus is further configured for compatibility with a range of containers, including primer and solvent cans, as well as various sizes of reservoirs. Interchangeable adapters may be provided to accommodate different container types, offering enhanced flexibility and ease of use.

The present invention is configured to attach to a wide variety of containers including, but not limited to, containers formed of a polypropylene material with anti-static properties. That is, the primer applicator apparatus may be used with any container—regardless of variation in shape, size, material, or configuration—that incorporates both polypropylene and anti-static characteristics. However, the present invention is not limited thereto. That is, the containers may be formed of a wide variety of materials, including nylon with or without anti-static properties.

The primer applicator is designed to work with a variety of container types—from standard primer and solvent cans to different-sized reservoirs. Swappable adapters can be used to fit the specific container, making the system more versatile and user-friendly. The applicator heads themselves can be either flexible or rigid, depending on the application needs.

Additionally, the applicator is designed to interface with a variety of standard applicator heads—either fixed or rotatable—to suit different application techniques. In further embodiments, custom applicator heads tailored for specific uses, such as automotive sealants, may be attached. However, the present general inventive concept is not limited thereto.

The present invention also provides a self-contained primer applicator apparatus that eliminates the need for manual dipping of daubers into a primer can, thereby significantly reducing the risk of spills and contamination.

The apparatus further includes a movable cover member configured to selectively expose varying lengths of the applicator pad or material, enabling precise control over the area available for fluid contact and application. The cover member may be configured to slide or have a cork-screw rotation to expose varying lengths of the applicator pad (i.e., an applicator member 110). However, the present general inventive concept is not limited thereto. The cover member may further include click notches to provide an indicator to the user of specific predetermined lengths of the applicator member exposure.

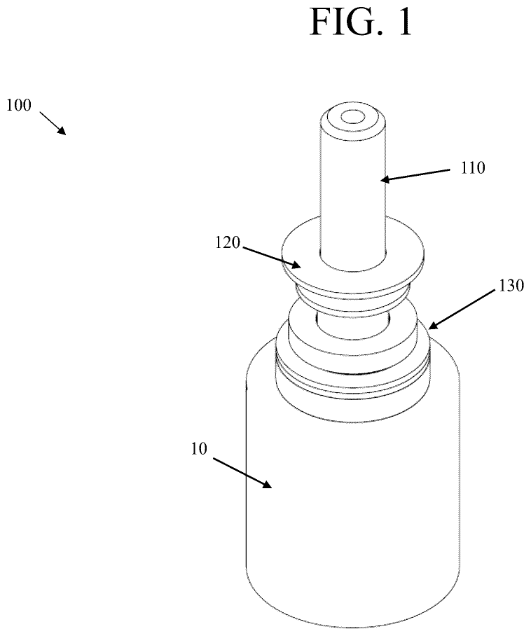

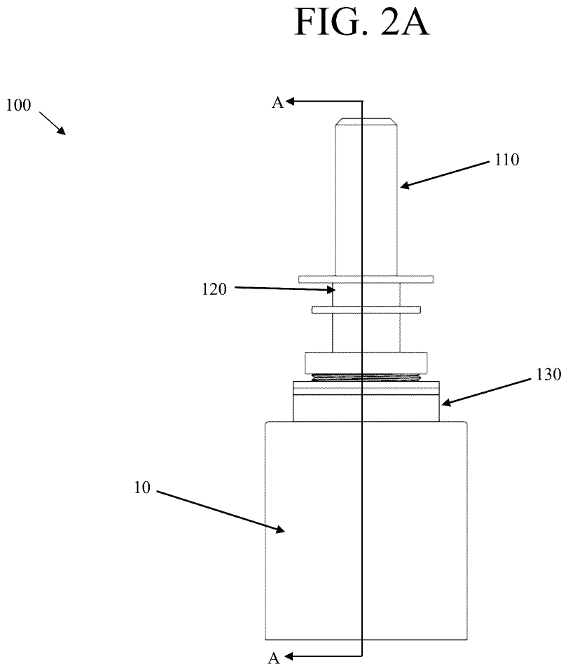

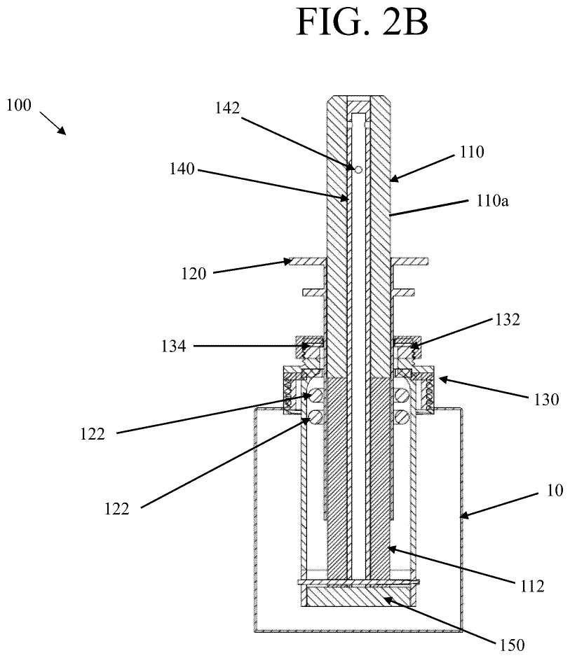

FIG. 1 is a front perspective view of a primer applicator apparatus 100, according to an exemplary embodiment of the present invention, FIG. 2A is a front view of the primer applicator apparatus 100 shown in FIG. 1 and FIG. 2B is a cross-sectional front view of the primer applicator apparatus 100 taken along line A-A of FIG. 2A.

Referring to FIGS. 1 through 2B, the primer applicator apparatus 100 includes an applicator member 210, a cover member 120 movably coupled to the applicator member 110, and a coupling member 130 with an integrated fill tube 140.

In the illustrated embodiment, the applicator member 110 is generally cylindrical and comprises an absorbent material suitable for retaining and applying primer. The primer applicator apparatus 100 may further include a second absorbent material 112 in fluid communication with or in contact with the applicator member 110.

In alternative embodiments, the applicator member 110 may be formed from one or more porous materials, including but not limited to foam, felt, bristles, or combinations thereof, as well as other absorbent or semi-absorbent materials.

Furthermore, the applicator member 110 may be formed of multiple materials with varying degrees of porosity strategically arranged to control the flow of fluid (e.g., primer or solvent) stored within the container 10 to the exposed portion of the applicator member 110. This configuration enables precise regulation of the amount of fluid delivered to the exposed surface of the applicator member 110 during use.

The porosity levels of both the applicator member 110, the second absorbent material 112, and absorbent material or felt 150 are specifically engineered to correspond with the intended flow rate of the particular fluid stored within the container 10.

These porosity characteristics are selected to promote controlled wicking of the fluid from the container to the applicator surface, ensuring the delivery of a precise amount of fluid while effectively preventing excessive flow or dripping.

The cover member 120 is operably mounted to the applicator member 110 and is capable of being positioned or moved to expose different lengths of the applicator surface 110a to the external environment 12.

The cover member 120 is operably mounted to the applicator member 110 and is configured to be positioned or moved to expose varying lengths of the applicator surface 110a to the external environment 12. The cover member 120 is further secured in place when a coupling member is tightened, thereby restricting movement and maintaining the desired exposure length of the applicator surface.

When the cover member 120 is in a first position, a first length of the applicator member 110 is exposed. When the cover member 120 is in a second position, a second length different than the first length of the applicator member 110 is exposed. This sliding or telescoping action provides adjustable control over the depth and area of primer application. However, the present general inventive concept is not limited thereto.

In exemplary embodiments, the applicator member 110 may have a longitudinal length from about 1 inch to about 18 inches. However, the present invention is not limited thereto.

Accordingly, users can regulate the extent of the applicator's exposure, allowing them to manage the depth of primer applied to a target surface with precision.

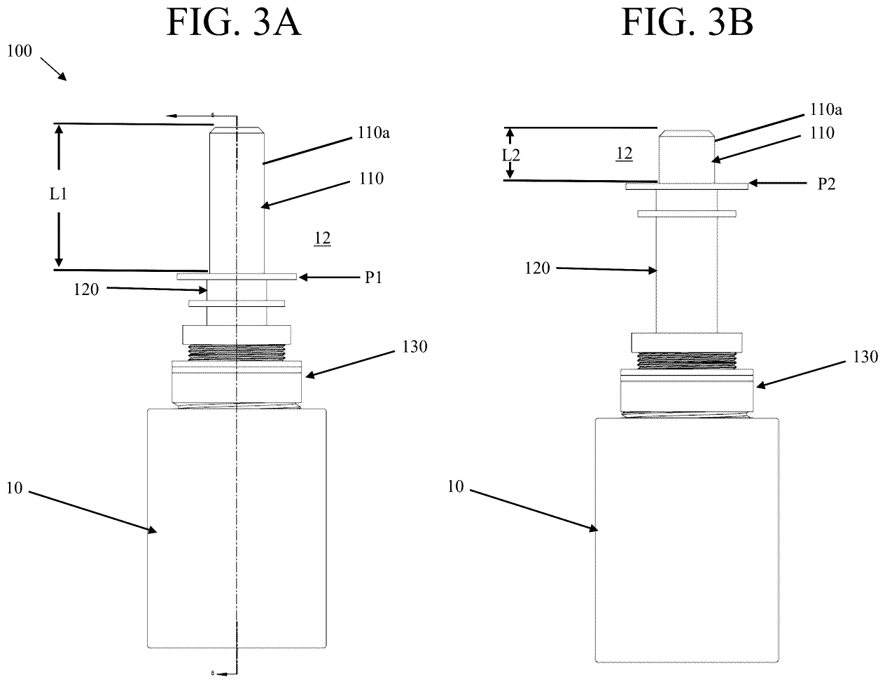

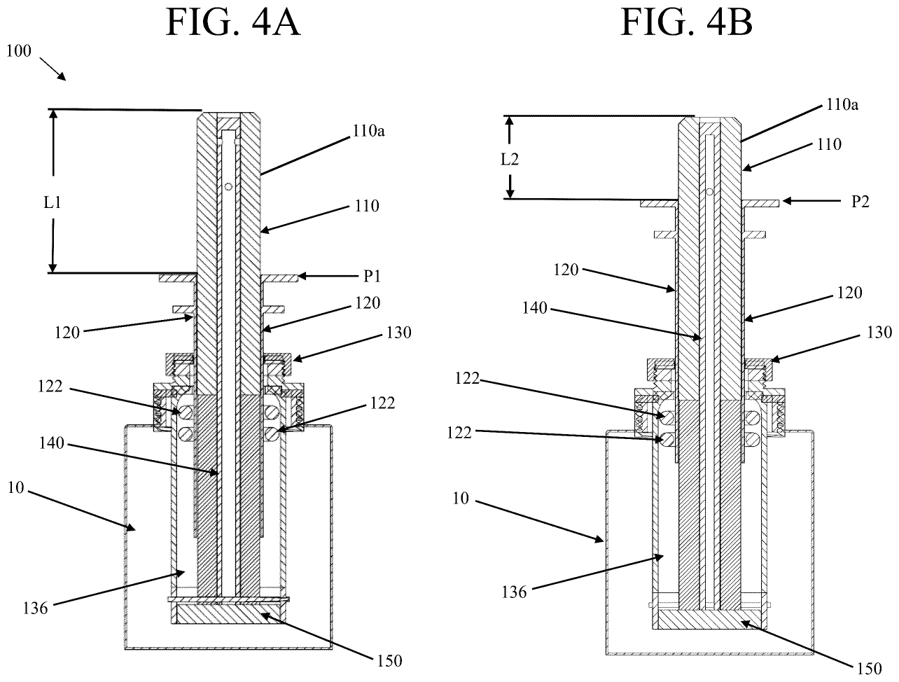

FIGS. 3A and 3B depict the primer applicator apparatus 100 with the cover member 120 in first and second positions (P1 and P2), respectively. FIGS. 4A and 4B show corresponding cross-sectional views illustrating the cover member's 120 relative position to the applicator member 110 in each state.

As shown, the cover member 120 is slidably engaged with the applicator member 110 and may be translated to expose selective portions of the applicator surface 110a. This allows for controlled primer or solvent application depending on the desired coverage depth.

In this embodiment, the cover member 120 fully encloses the applicator member 110 when in the retracted position. In extended configurations, it reveals designated lengths of the applicator surface 110a for use.

The first exposed length (L1) may range between approximately 4 inch and 6 inches, while the second exposed length (L2) may range from approximately 1 inches to 3 inches. However, alternative dimensions may be used depending on the application requirements.

For example, when the cover member 120 is set to a first configuration, a 2-inch section of the applicator member 110 may be exposed. When adjusted to a second configuration, a 4-inch section may be exposed. These measurements are exemplary and not limited thereto.

Through its adjustable design, the cover member 120 enables the user to finely control the exposed surface area of the applicator member 110. This feature facilitates consistent and repeatable application of primer or solvent to a desired surface.

In this embodiment, the cover member 120 is dimensioned to fully enclose the applicator member 110, effectively shielding the outer surface of the applicator member 110 from exposure to the external environment 12. When the cover member 120 is retracted to a different position, a predefined length of the applicator member 110 becomes exposed for application of primer or solvent.

In alternative embodiments, the cover member 120 is continuously adjustable between a fully retracted position and a fully extended position, allowing variable positioning to control the extent of exposure of the applicator member 110.

In alternative embodiments, the primer applicator apparatus 100 includes one or more gaskets or O-rings 122 to help support and stabilize the cover member 120 when moved between the fully retracted position and the fully extended position.

In alternative embodiments, the applicator member 110 may be formed in various shapes and dimensions to accommodate different application requirements. It may also be constructed from diverse absorbent materials or pad configurations suitable for retaining and dispensing liquid primer stored in the associated container.

The coupling member 130 in the current embodiment is configured to securely connect the cover member 120 to a container, such as a standard primer can. However, the invention is not limited to such configurations. In other embodiments, the coupling member 130 may be designed to interface with custom primer containers, including compressible reservoirs, enabling controlled dispensing of primer or solvent to the applicator member 110.

In the present embodiment, the applicator member 110 is removably secured to the coupling member 130 and is further configured to rotate relative to the coupling member 130, thereby enabling replacement or adjustment of the applicator member 110.

To prevent leakage during operation, the coupling member 130 incorporates a sealing mechanism that engages the cover member 120. In one embodiment, this sealing mechanism comprises a sealing member 132 formed by a gasket or rubber O-ring 134 seated within the internal housing of the coupling member 130. This configuration ensures that liquid primer within the container does not escape through the coupling interface during movement of the cover member 120.

The primer applicator apparatus 100 further includes a fill tube 140, preferably cylindrical, with a first end extending into the applicator member 110 and a second, opposing end extending into the interior of the primer container 10. The second end of the fill tube 140 may be coupled against an absorbent material or felt 150 that helps control a flow of primer stored within the primer container flowing into the fill tube 140. The fill tube 140 allows for an even distribution of the primer within the primer container 10 into the applicator member 110, thereby allowing for an even application of the primer onto a desired surface. The fill tube 140 may include a plurality of holes 142 that are evenly spaced within the applicator member 110. However, the present general inventive concept is not limited thereto.

In alternative configurations, the fill tube 140 (or transfer tube) may be hollow and include at least one through-hole 142 to facilitate the controlled transfer of primer from the container to the applicator member 110.

In alternative embodiments, the fill tube 140 may further include an absorption material disposed within the fill tube 140 to further assist in controlling the flow of extremely thin fluids.

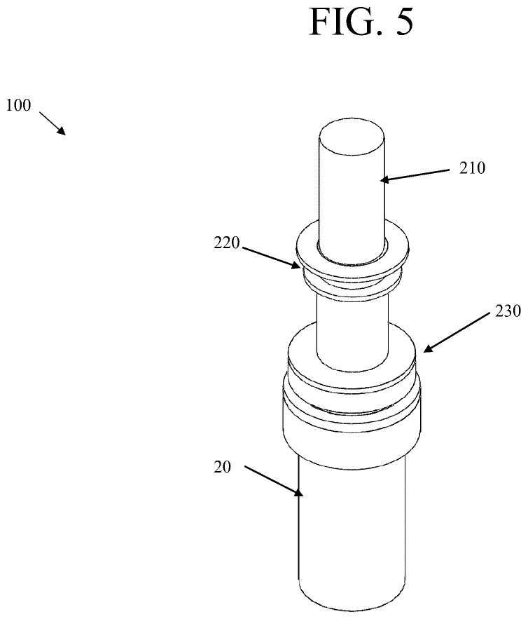

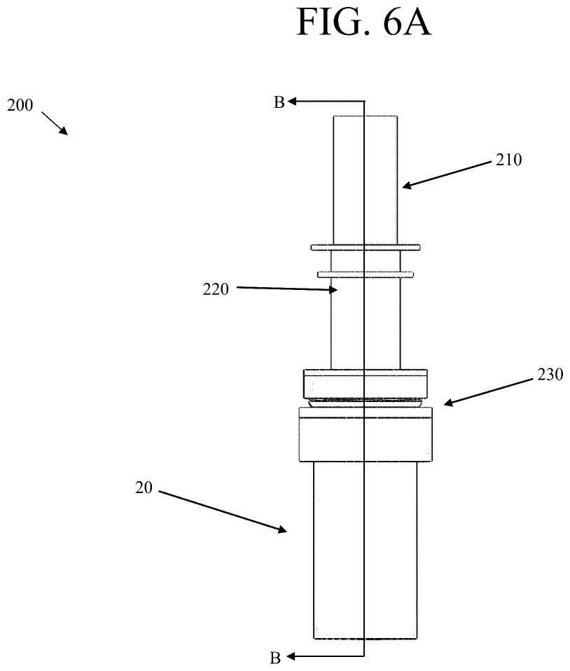

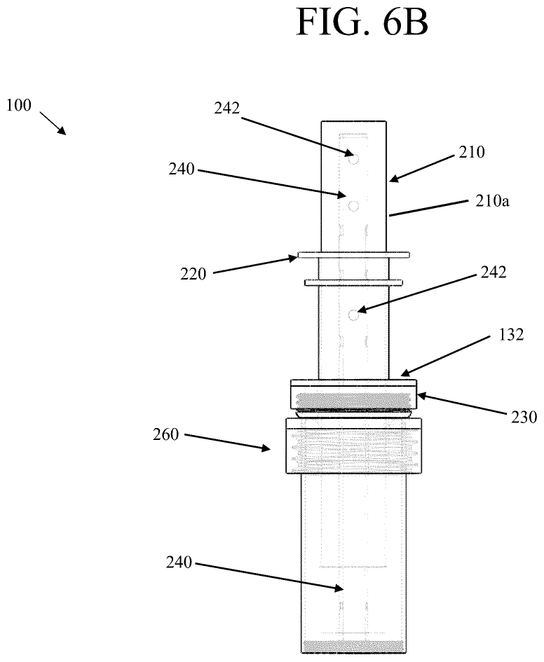

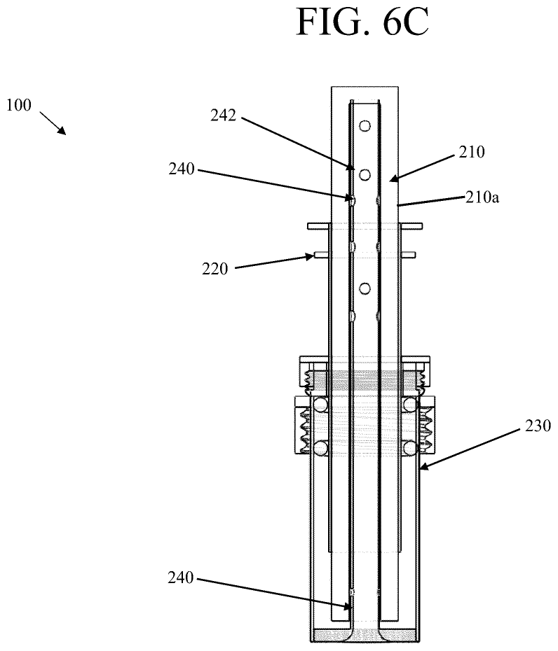

FIG. 5 is a front perspective view of a primer applicator apparatus 200, according to another exemplary embodiment of the present invention, FIG. 6A is a front view of the primer applicator apparatus 200 shown in FIG. 5, and FIG. 6B is a front view of the primer applicator apparatus 200 shown in FIG. 5, illustrating hidden lines. FIG. 6C is a cross-sectional front view of the primer applicator 200 apparatus taken along line B-B of FIG. 6A.

Referring to FIGS. 5 through 6C, the primer applicator apparatus 200 includes an applicator member 210, a cover member 220 movably coupled to the applicator member 210, and a coupling member 230 with an integrated fill tube 240. The present embodiment is similar to the previous primer applicator apparatus 100, except the coupling member 230 is formed integrally with a fill tube 240.

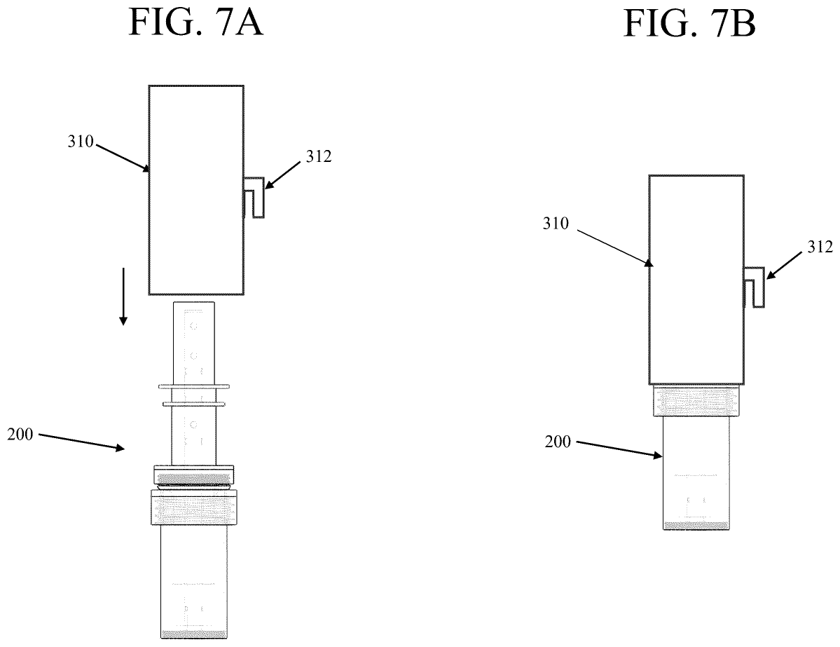

FIG. 7A is partial assembly front view of a primer applicator 200 and an applicator holder 310 according to another embodiment of the present invention and FIG. 7B is fully assembled front view of the primer applicator 200 and the applicator holder 310 illustrated in FIG. 7A.

In alternative embodiments, the primer applicator apparatus 200 includes an applicator holder 310 which is design to shield the applicator member and cover member from the external environment. The applicator holder 310 further includes a belt clip 312 to securely fasten to a user's belt or pants.

The present invention relates to a dispensing tool configured for the controlled application of a liquid compound—such as sealants, adhesives, or coatings—onto cylindrical surfaces such as pipes or tubing. The tool comprises a bottle-like body that may be selectively attached to various commercial containers of the liquid substance. Upon user actuation—such as by squeezing or pumping—the liquid is expelled through an outlet positioned for optimal surface contact, enabling neat and efficient application.

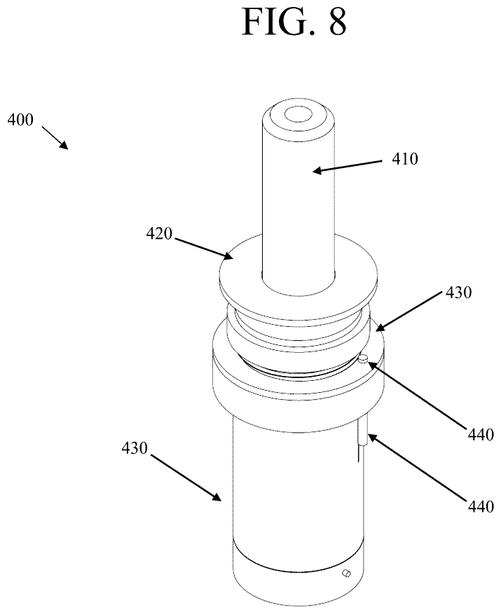

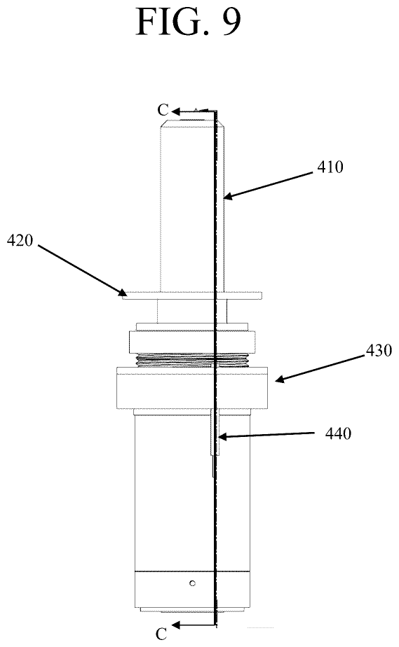

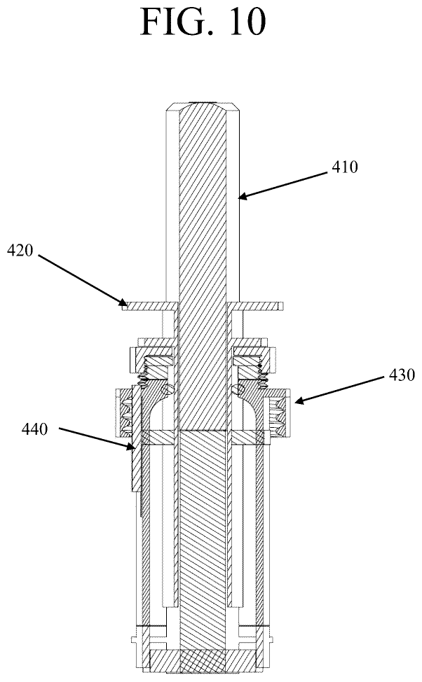

FIG. 8 is a front perspective view of a primer applicator apparatus 400, according to another exemplary embodiment of the present invention, FIG. 9 is a front view of the primer applicator apparatus 400 shown in FIG. 8 and FIG. 10 is a front cross-sectional view of the primer applicator apparatus 400 shown in FIG. 8, along line C-C.

Referring to FIGS. 8 through 10, the primer applicator apparatus 400 includes an applicator member 410, a cover member 420 movably coupled to the applicator member 410, and a coupling member 430 with an integrated fill mechanism 440. The present embodiment is similar to the previous primer applicator apparatus 200, except the coupling member 430 includes a fill mechanism 440 configured to facilitate the refilling of the material reservoir with a liquid compound from user.

The device is designed with adaptability in mind, allowing for adjustment to accommodate pipes of differing diameters. It includes structural features that minimize spillage and ensure the liquid is applied precisely to the target area. The tool is further equipped with a clip or hook for convenient attachment to a user's belt or pocket, enhancing portability.

To accommodate liquids of varying viscosities, the device incorporates internal flow-regulation components that control the amount of liquid dispensed. Additionally, the tool may optionally include an integrated pumping mechanism—either manually actuated (e.g., via a squeeze bulb) or battery-operated—to assist in delivering the liquid from the container to the applicator tip. This modular design allows users to select the pumping system most suitable to their needs and application environment.

Additionally, in some embodiments, the coupling member may be provided with a flow control cavity 136 that houses the fill tube 140. This cavity 136 is configured to manage and regulate the flow of fluid—such as primer—between the container 10 and the applicator member 110, ensuring consistent and measured delivery during use.

In some embodiments, the flow control portion of the applicator may include one or more mechanisms designed to regulate the release of material from the container to the applicator member. Suitable flow control mechanisms may include, but are not limited to, mechanical valves (e.g., check valves or spring-loaded valves), internal chambers that meter the fluid volume, porous media that allow capillary action or slow diffusion, constriction channels that limit flow by design, or gravity-based regulating structures that rely on orientation or angle to control the rate of flow. These configurations may be used alone or in combination to ensure consistent and controlled dispensing of the material during application.

In some embodiments, the tool may include a container or canister having a defined shape or orientation to enhance functionality, usability, or aesthetic appeal. For example, the container may be cylindrical, elliptical or tapered and may include an internal channel aligned with the longitudinal axis of the container to facilitate consistent fluid flow or ergonomic handling. The overall geometry of the tool may be configured to support single-handed use, alignment with target surfaces, or compatibility with storage and packaging formats. While such shape and orientation features are not essential to the operation of the tool, they may contribute to improved user experience or commercial differentiation and may form the basis for related design protection.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of the present invention.

What is claimed is:

1. A primer applicator apparatus comprising:
an applicator member;
a cover member movably coupled to the applicator member, the cover member configured to move to expose at least a portion of the applicator member; and
a coupling member configured to attach the applicator member to a primer container.

2. The primer applicator apparatus of claim 1, wherein the coupling member further includes a sealing member to prevent primer stored within the primer container from leaking through the coupling member.

3. The primer applicator apparatus of claim 2, wherein the sealing member comprises a gasket.

4. The primer applicator apparatus of claim 2, further comprising a fill tube disposed within the applicator member and extending into the primer container, the fill tube configured to transfer the primer to the applicator member,

5. The primer applicator apparatus of claim 3, wherein the fill tube is hollow to allow the primer to flow to the applicator member.

6. The primer applicator apparatus of claim 4, wherein fill tube includes at least one thru hole to control the flow of the primer to the applicator member.

7. The primer applicator apparatus of claim 1, wherein the coupling member further includes a flow control portion to control a flow of the primer to the applicator member.

8. The primer applicator apparatus of claim 1, wherein the cover member moves between a first position to a second position.

9. The primer applicator apparatus of claim 8, wherein the first position of the cover member corresponds to a first length of the applicator member exposed to an external environment and the second position of the cover member corresponds to a second length of the applicator member exposed to the external environment,

10. The primer applicator apparatus of claim 1, wherein the coupling member is configured to attach to a squeezable container.

11. The primer applicator apparatus of claim 1, wherein the applicator member is comprises a porous material including, or formed from, one or more of foam, felt, bristles, a combination thereof or other absorbent or semi-absorbent material.

12. The primer applicator apparatus of claim 1, wherein the applicator member is removably secured and is further configured to rotate relative to the coupling member, thereby enabling replacement or adjustment of the applicator member.

13. The primer applicator apparatus of claim 1, wherein the cover member is continuously adjustable between a fully retracted position and a fully extended position, allowing variable positioning to control the extent of exposure of the applicator member.

14. The primer applicator apparatus of claim 1, wherein the cover member and the coupling member are constructed of chemical-resistant plastic.

15. The primer applicator apparatus of claim 1, further comprising a removable applicator cap that, when detached, exposes a filing aperture of the container, thereby allowing the user to refill the container without requiring additional tools or modifications.

16. A method of applying primer to a surface using a primer applicator apparatus, the method comprising:
attaching a coupling member of a primer applicator apparatus to a primer container, the primer applicator apparatus comprising:
an applicator member;
a cover member movably coupled to the applicator member; and
a coupling member configured to attach to the primer container;
preventing leakage of the primer from the primer container by sealing the connection using a sealing member within the coupling member;
allowing primer to flow from the primer container through a fill tube disposed within the applicator member, the fill tube having at least one through hole for controlled fluid transfer;
exposing at least a portion of the applicator member by moving the cover member to a first position; and
applying the primer from the applicator member onto a target surface.
